(19) United States
(12) Patent Application Publication
(10) Pub. No.: US 2010/0103318 A1
(43) Pub. Date: Apr. 29, 2010

(54) PICTURE-IN-PICTURE DISPLAY APPARATUS HAVING STEREOSCOPIC DISPLAY FUNCTIONALITY AND PICTURE-IN-PICTURE DISPLAY METHOD

(75) Inventors: Chih-Li Wang, Taipei (TW); Hung-Yang Hsu, Taipei (TW); Pin-Hsien Su, Taipei (TW)

Correspondence Address: CHOATE, HALL & STEWART LLP, TWO INTERNATIONAL PLACE, BOSTON, MA, 02110, US

(73) Assignee: Wistron Corporation, Taipei Hsien (TW)

(21) Appl. No.: 12/431,960

(22) Filed: Apr. 29, 2009

(30) Foreign Application Priority Data
Oct. 27, 2008 (TW) 097141174

(51) Int. Cl. H04N 5/45

(52) U.S. Cl. 348/565; 348/E05.112

(57) ABSTRACT

A picture-in-picture display apparatus having stereoscopic display functionality includes a receiving unit for receiving first and second data sets, an image processing unit for performing computational processing to convert two-dimensional data to three-dimensional data or to convert three-dimensional data to two-dimensional data with respect to the first data set and/or the second data set, and a display unit. The display unit has a main picture display zone and a sub-picture display zone. The first and second data sets are respectively displayed in the main picture display zone and the sub-picture display zone.

### CROSS-REFERENCE TO RELATED APPLICATION

This application claims priority of Taiwanese Application No. 097141174, filed on Oct. 27, 2008, which is incorporated herein by reference.

### BACKGROUND OF THE INVENTION

1. Field of the Invention

The invention relates to a picture-in-picture display technique, more particularly to a picture-in-picture display technique capable of presenting two-dimensional and three-dimensional images at the same time.

2. Description of the Related Art

In a conventional display apparatus having picture-in-picture (hereinafter referred to as PIP for short) functionality, input signals from two different sources are respectively outputted to a main picture display zone and a sub-picture display zone of the display apparatus, or are processed into a PIP signal which is subsequently outputted to the display apparatus, whereby the main picture display zone and the sub-picture display zone can respectively display the two input signals.

To pursue more realistic visual effects, various stereoscopic display techniques have been developed recently, such as space-multiplexed polarization type stereoscopic display techniques (polarized glasses required), time-multiplexed light valve type stereoscopic display techniques (light valve glasses required), multiple-view stereoscopic display techniques that do not require any stereoscopic glasses, etc. The aforementioned stereoscopic display techniques are all based on the principle of stereoscopic vision of human eyes, and efforts are made to improve display hardware and image processing software, so that an image intended for viewing with the left eye enters the left eye of a viewer and an image intended for viewing with the right eye enters the right eye of the viewer to thereby produce a stereoscopic picture in the brain of the viewer.

However, conventional stereoscopic display apparatuses are capable of full-screen stereoscopic display or are capable of switching between full-screen two-dimensional (2D) display and full-screen three-dimensional (3D) display, and are incapable of allowing a user to view three-dimensional images either in a main picture display zone or in a sub-picture display zone of a PIP display apparatus.

### SUMMARY OF THE INVENTION

Therefore, an object of the present invention is to overcome the problems associated with the aforementioned prior art by providing a PIP display apparatus having stereoscopic display functionality, which is capable of presenting two-dimensional and three-dimensional images simultaneously.

Another object of the present invention is to provide a PIP display method for presenting two-dimensional and three-dimensional images simultaneously.

The PIP display apparatus having stereoscopic display functionality according to the present invention may be a television set or a display connected to a computer device, and includes a receiving unit, an image processing unit, and a display unit.

In the case that the PIP display apparatus is a television set, the receiving unit includes two video terminals that respectively receive a first data set and a second data set. In the case that the PIP display apparatus is a display connected to a computer device, the receiving unit is a connection port connected to the computer device for receiving the first and second data sets, which are in the form of documents or in audiovisual format, and which are transmitted from the computer device.

The image processing unit is connected to the receiving unit, executes preset programs, and, depending on design, makes determinations as to whether the first data set and/or the second data set is three-dimensional image data for conducting subsequent computational processing to convert two-dimensional data to three-dimensional data or vice versa. The display unit has a main picture display zone and a sub-picture display zone. The first data set is correspondingly displayed in the main picture display zone, and the second data set is correspondingly displayed in the sub-picture display zone. For example, if the PIP display apparatus is configured to display two-dimensional images in the main picture display zone and to display three-dimensional images in the sub-picture display zone, the image processing unit only needs to determine whether the second data set is three-dimensional image data, and to convert the second data set to three-dimensional image data if the second data set is not three-dimensional image data. For the conversion of two-dimensional data to three-dimensional data or vice versa, any conventional computational processing technique can be employed, such as a method for converting two-dimensional images to stereo three-dimensional images disclosed in Taiwanese Patent Application Publication No. 200810519, in which values of depth of scene and displacement are adjusted after partitioning of a two-dimensional image so as to obtain left eye image data and right eye image data. The sub-picture display zone of the display unit is distinguished from the main picture display zone by attaching a stereoscopic display sheet thereto. Alternatively, a stereoscopic display sheet is attached to both the main picture display zone and the sub-picture display zone, and the position and size of the sub-picture display zone is software-defined. The stereoscopic display sheet may be one of a polarized sheet and a lenticular sheet. The stereoscopic display technique adopted in the present invention does not include holography and volumetric stereoscopic display techniques. Additionally, in order to avoid adversely affecting viewing of two-dimensional images by the user, stereoscopic imaging techniques that require users to wear glasses with red and cyan filter lenses are not suitable for use by the present invention.

In addition, the PIP display method of this invention may be designed to take the following forms. In one form, the PIP display apparatus is a display connected to a computer device. When the computer device is connected to an image acquiring or playback device (e.g., a medical sensor such as an ultrasonic probe, or a digital video recorder), a command to open a new window is automatically generated and is transmitted to the receiving unit. The display unit opens a window in the position of the sub-picture display zone according to the command to open a new window, and displays the second data set from the image acquiring or playback device in the window thus opened.

In another form, a stereoscopic display sheet is attached to the entire display unit of the PIP display apparatus. The receiving unit further receives a switch command. The switch command is given via a TV remote controller or a specific key on a computer keyboard. When the switch command is received by the receiving unit, the image processing unit will provide a switch menu for displaying by the display unit. The menu provides four options to display a two-dimensional or three-dimensional image on each of the main picture display zone and the sub-picture display zone: “2D-3D” which indicates that the main picture is two-dimensional whereas the sub-picture is three-dimensional; “2D-2D” which indicates that the main picture and the sub-picture are both two-dimensional; “3D-2D” which indicates that the main picture is three-dimensional whereas the sub-picture is two-dimensional; and “3D-3D” which indicates that the main picture and the sub-picture are both three-dimensional.

When the receiving unit further receives a switch selection command to select one option from the switch menu, the image processing unit determines whether the first data set and the second data set being displayed match the switch selection command. If not, the computational processing to convert the first data set and/or the second data set to two-dimensional or three-dimensional data is performed according to the switch selection command.

Certainly, when the receiving unit receives the switch command, instead of providing a menu, the image processing unit is caused to perform computational processing to convert one of the first and second data sets from two-dimensional data to three-dimensional data. For example, when a switch command is received for the first time, conversion of the first data set is performed. When the switch command is received for the second time, conversion of the second data set is performed. When the switch command is received for the third time, the first data set is converted again, and when the switch command is received for the fourth time, the second data set is converted again.

By virtue of the above configurations, the present invention is able to provide a PIP display apparatus having stereoscopic display functionality to enable the user to view two-dimensional and/or three-dimensional images in the main picture display zone and the sub-picture display zone directly or through simple operations.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram of an embodiment of a PIP display apparatus having stereoscopic display functionality;

FIG. 2 is a flowchart to illustrate an embodiment of a PIP display method;

FIG. 3 is a schematic diagram to illustrate an embodiment of a main picture and a sub-picture displayed on a display unit;

FIG. 4 is a block diagram of another embodiment of a PIP display apparatus having stereoscopic display functionality;

FIG. 5 is a flowchart to illustrate another embodiment of PIP display method;

FIG. 6 is a block diagram of another embodiment of a PIP display apparatus having stereoscopic display functionality;

FIG. 7 is a flowchart to illustrate another embodiment of a PIP display; and

FIG. 8 is a flowchart to illustrate an embodiment of a PIP display method executed by an embodiment of a PIP display apparatus having stereoscopic display functionality.

### DETAILED DESCRIPTION

Before embodiments of the present invention is described in greater detail, it should be noted that like elements are denoted by the same reference numerals throughout the disclosure.

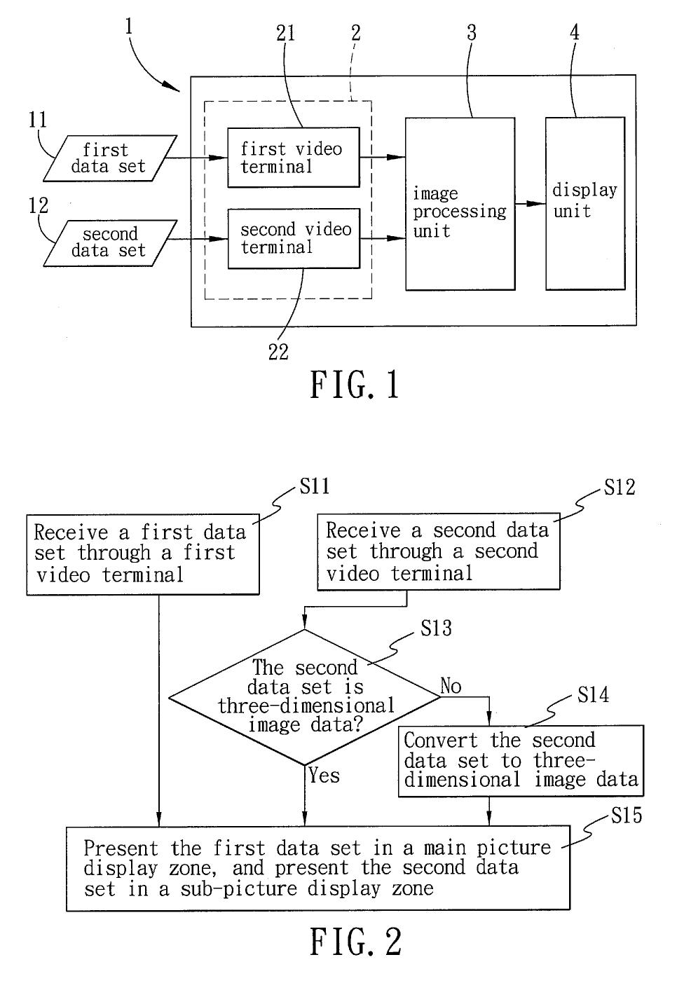

Referring to FIGS. 1 and 2, an embodiment of a PIP display apparatus 1 having stereoscopic display functionality is a liquid crystal digital television set that has a receiving unit 2, an image processing unit 3 connected to the receiving unit 2, and a display unit 4 connected to the image processing unit 3. The receiving unit 2 of this embodiment includes a first video terminal 21 and a second video terminal 22 for receiving a first data set 11 and a second data set 12, respectively. The first and second data sets 11, 12 referred to herein are television signals, such as television channel signals supplied by TV station X and TV station Y.

The image processing unit 3 of this embodiment can determine whether the second data set 12 is three-dimensional image data, i.e., determining whether the second data set 12 includes left eye image data and right eye image data. If not, the second data set 12, which is otherwise two-dimensional image data, is converted to three-dimensional image data.

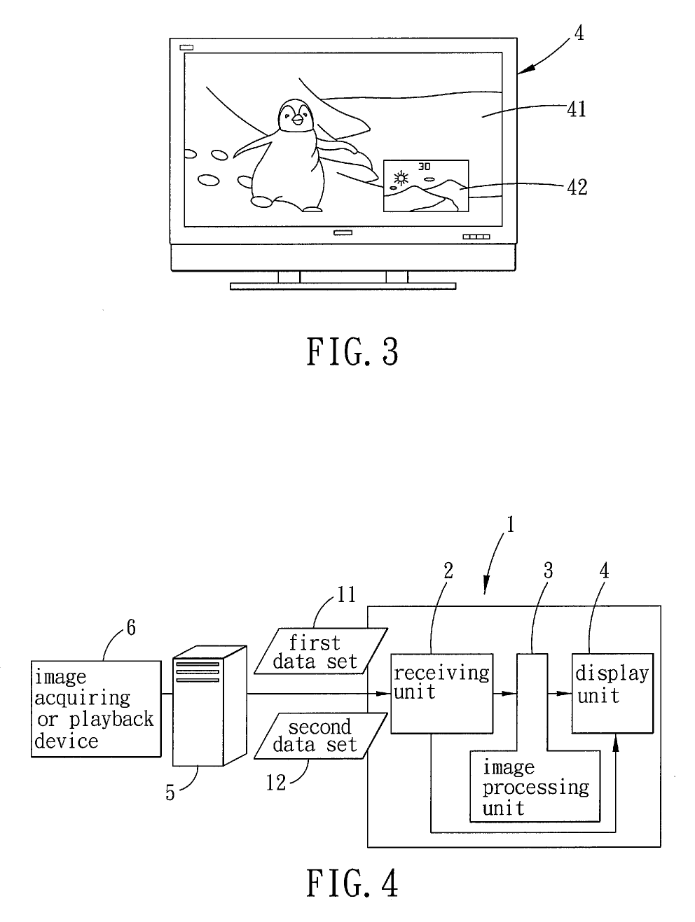

Referring to FIG. 3, the display unit 4 has a main picture display zone 41 and a sub-picture display zone 42. The sub-picture display zone 42 is distinguished from the main picture display zone 41 by attaching a stereoscopic display sheet (not shown) to an outer side of an internal display substrate panel thereof. The stereoscopic display sheet may vary depending on the stereoscopic display technique employed. For example, the stereoscopic display sheet refers to a polarized sheet if a space-multiplexed polarization type stereoscopic display technique (polarized glasses required) is adopted, and refers to a lenticular sheet if a multiple-view stereoscopic display technique is employed, without being limited to this embodiment.

The display method executed by the PIP display apparatus 1 of this embodiment includes the following steps:

In steps S11 and S12, the first video terminal 21 and the second video terminal 22 respectively receive the first data set 11 and the second data set 12.

In step 13, the image processing unit 3 receives the first data set 11 and the second data set 12, and determines if the second data set 12 is three-dimensional image data. If so, step S15 is executed. If not, step S14 is executed.

In step S14, the image processing unit 3 converts the second data set 12 from two-dimensional image data to three-dimensional image data.

In step S15, the first data set 11 and the three-dimensional second data set 12 are transmitted to the display unit 4. The first data set 11 is for presenting in the main picture display zone 41, and the three-dimensional second data set 12 is for presenting in the sub-picture display zone 42.

The PIP display apparatus 1 of this embodiment can thus present two-dimensional and three-dimensional pictures simultaneously so that a user can view both two-dimensional and three-dimensional images at the same time.

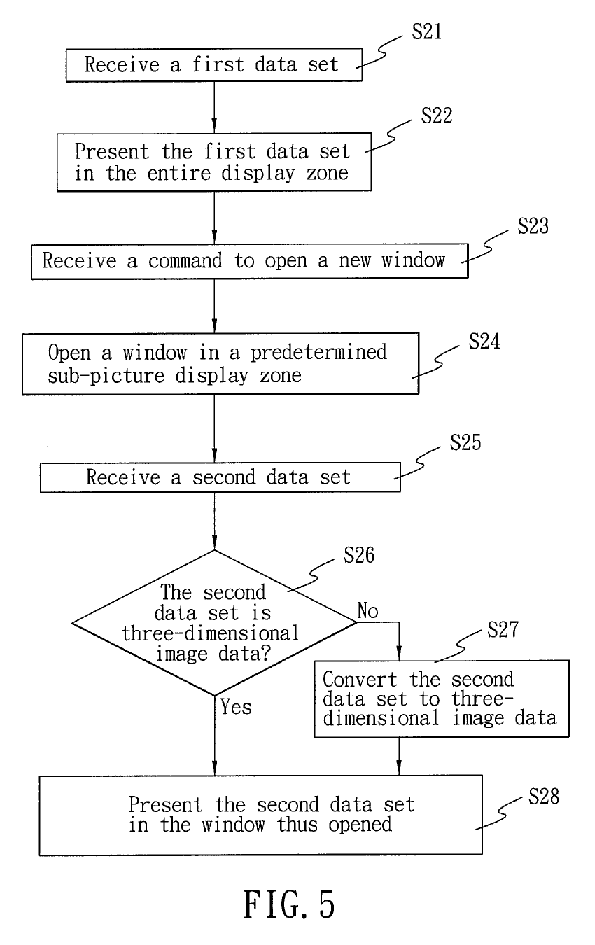

Referring to FIGS. 4 and 5, another embodiment of a PIP display apparatus 1 having stereoscopic display functionality is a display connected to a computer device 5, and is more suited for use as medical display equipment or a surveillance display. The PIP display apparatus 1 of this embodiment likewise includes a receiving unit 2, an image processing unit 3, and a display unit 4. The receiving unit 2 of this embodiment is a connection port for connection to the computer device 5. The image processing unit 3 is likewise used to determine if the second data set 12 is three-dimensional image data. The sub-picture display zone 42 of the display unit 4 is also distinguished from the main picture display zone 41 by attaching a stereoscopic display sheet thereto.

The display method executed by the PIP display apparatus 1 of this embodiment includes the following steps:

In step S21, the receiving unit 2 receives the first data set 11 from the computer device 5. The first data set 11 may be a file document, such as clinical history data.

In step S22, the display unit 4 receives the first data set 11 from the receiving unit 2, and causes the first data set 11 to be presented in the entire display zone.

In step S23, the receiving unit 2 receives a command to open a new window. The command to open a new window in this embodiment is automatically issued by the computer device 5 when the computer device 5 is connected to an image acquiring or playback device 6, e.g., an ultrasonic probe, a digital video recorder, etc. Certainly, the command to open a new window may be configured to be issued through manipulation of the computer. It is noted that the PIP display apparatus 1 will continue to present the first data set 11 in the entire display zone if the command to open a new window is not generated.

In step S24, the image processing unit 3 receives the command to open a new window from the receiving unit 2, and opens a window in the position of the sub-picture display zone 42 according to predetermined (program-preset) coordinates for presenting on the display unit 4.

In step S25, the receiving unit 2 receives the second data set 12 from the image acquiring or playback device 6. The second data set 12 is image data, such as an image acquired by an ultrasonic probe or a video recorder.

In step S26, the image processing unit 3 receives the second data set 12 from the receiving unit 2, and determines if the second data set 12 is three-dimensional image data. If so, step S28 is executed. If not, step S27 is executed.

In step S27, the image processing unit 3 converts the second data set 12, which is two-dimensional image data, to three-dimensional image data.

In step S28, the second data set 12 is outputted for presenting a corresponding image in the window that was opened in step S24.

Thus, the user can view two-dimensional data under normal circumstances, and can view two-dimensional data, such as file documents, and three-dimensional image data at the same time when required.

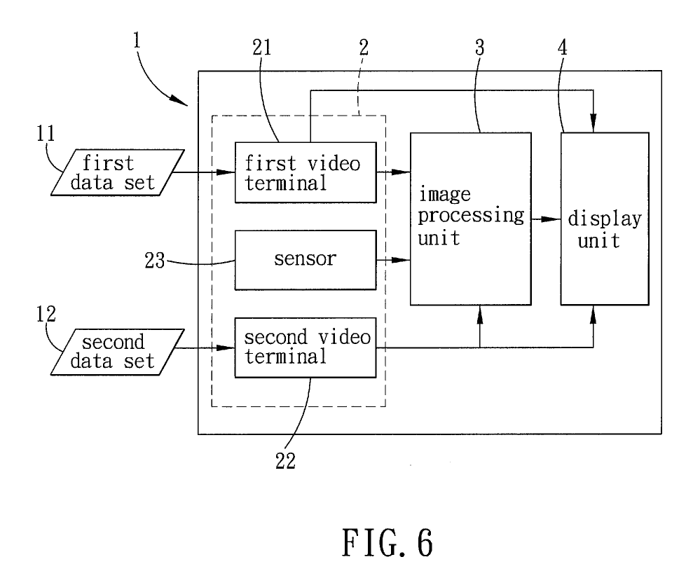

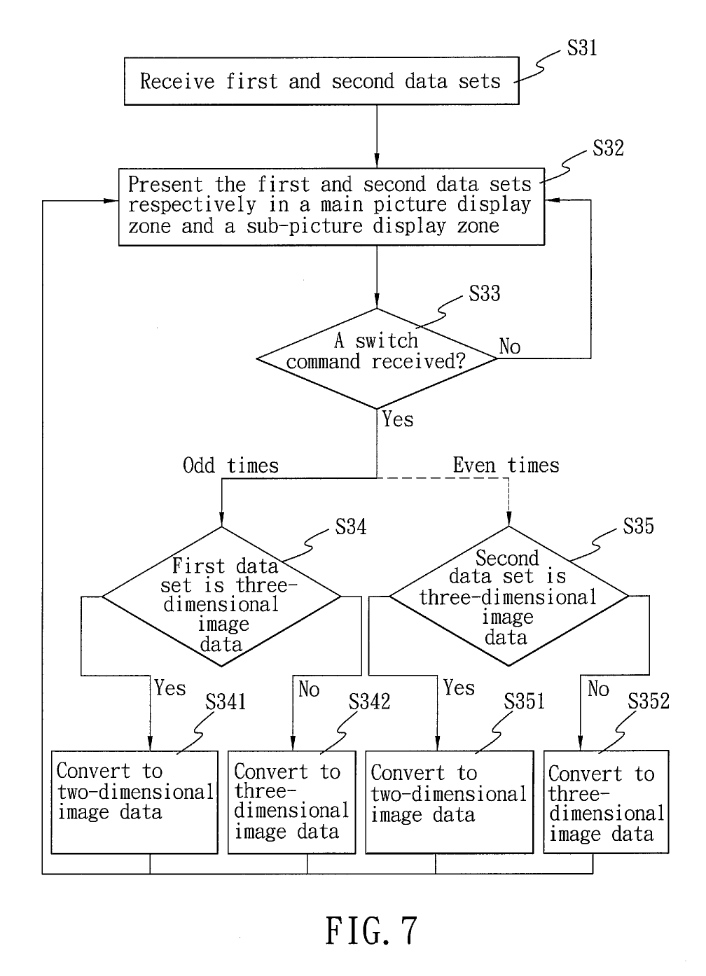

Referring to FIGS. 6 and 7, an embodiment of a PIP display apparatus 1 having stereoscopic display functionality is exemplified as a television set, which similarly has a receiving unit 2, an image processing unit 3, and a display unit 4. The receiving unit 2 of this embodiment includes a first video terminal 21 and a second video terminal 22 for receiving a first data set 11 and a second data set 12, respectively, and a sensor 23 for receiving a switch command. In this embodiment, the switch command is generated through pressing a specific button on a TV remote controller. It is noted that the PIP display apparatus 1 may also be a display connected to a computer device. In this case, the receiving unit 2 is a connection port connected to the computer device for receiving data and commands transmitted therefrom. The switch command is given through pressing a specific key on a computer keyboard.

The display unit 4 of this embodiment is required to have a stereoscopic display sheet attached to the entire display panel thereof, and has a main picture display zone 41 and a software-defined sub-picture display zone 42 as shown in FIG. 3.

The PIP display method executed by the PIP display apparatus 1 of this embodiment includes the following steps:

In step S31, the first video terminal 21 of the receiving unit 2 receives the first data set 11, and the second video terminal 22 receives the second data set 12.

In step S32, the display unit 4 receives the first and second data sets 11, 12 from the receiving unit 2, which are for presenting respectively in the main picture display zone 41 and the sub-picture display zone 42. In this step, the first data set 11 and the second data set 12 are correspondingly processed according to whether they are two-dimensional image data or three-dimensional image data. For example, if the first data set 11 is two-dimensional image data and the second data set 12 is time-multiplexed three-dimensional image data, the first data set 11 is directly presented in the main picture display zone 41, whereas left eye image data and right eye image data contained in the second data set 12 are alternately presented in the sub-picture display zone 42 according to predetermined frequencies. As another example, if the second data set 12 is space-multiplexed three-dimensional image data, the left eye image data and the right eye image data are respectively presented in alternate rows or columns of the sub-picture display zone 42.

In step S33, it is determined if the sensor 23 has received a switch command. If so, step S34 is executed for a switch command that is received for the first or third time or an odd number of times, and step S35 is executed for a switch command that is received for the second or fourth time or an even number of times. If no switch command is received, step S32 is repeated to perform the presenting operation.

In step S34, the image processing unit 3 determines if the first data set 11 is three-dimensional image data. If so, step S341 is executed to convert the first data set 11 to two-dimensional image data using a technique such as one that neglects the left eye or right eye image data. For time-multiplexing, only the retained right eye or left eye image data is presented. For space multiplexing, the retained right eye or left eye image is displayed in the entire sub-picture display zone 42. If the first data set 11 is not three-dimensional image data, step S342 is executed to convert the first data set 11 to three-dimensional image data using the above-mentioned technique. Thereafter, the flow returns to step S32 to present the converted first data set 11.

In step S35, the image processing unit 3 determines if the second data set 12 is three-dimensional image data. If so, step 5351 is executed to convert the second data set 12 to two-dimensional image data. If not, step S352 is executed to convert the second data set 12 to three-dimensional image data. The flow then returns to step S32 to present the converted second data set 12.

Thus, the user can switch between two-dimensional images and three-dimensional images in the main picture display zone 41 and the sub-picture display zone 42 by manipulating a TV remote controller so as to obtain image combinations of “2D-3D,” “2D-2D,” “3D-2D,” and “3D-3D.”

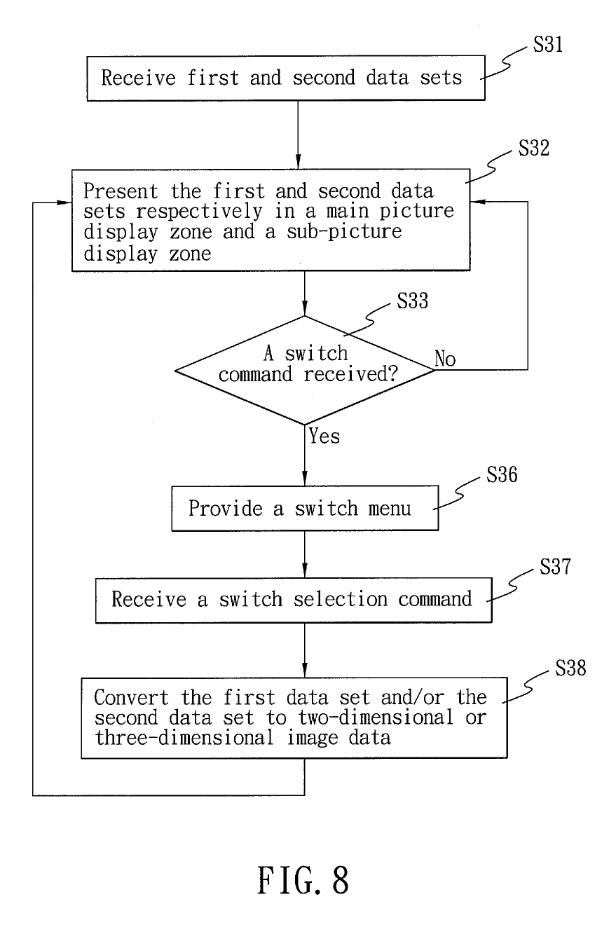

Referring to FIGS. 6 and 8, another embodiment of a PIP display apparatus 1 having stereoscopic display functionality is similar to the embodiment described above in connection with FIGS. 6 and 7. The difference resides only in that, when the sensor 23 receives the switch command in step S33, the image processing unit 3 does not proceed directly with determination and conversion of the first and second data sets 11, 12. Instead, the following steps S36-S38 are executed.

In step S36, the image processing unit 3 provides a switch menu for display on the display unit 4. The menu provides four options for selection by the user to display two-dimensional or three-dimensional images in the main picture display zone 41 and the sub-picture display zone 42, namely, “2D-3D,” “2D-2D” “3D-2D,” and “3D-3D.”

In step S37, the sensor 23 of the receiving unit 2 further receives a switch selection command to select a specific option from the switch menu. This step is illustrated using an example in which the option “3D-2D” is selected, i.e., three-dimensional image data to be presented in the main picture display zone 41 and two-dimensional image data to be presented in the sub-picture display zone 42.

In step S38, the image processing unit 3 determines if the first data set 11 and the second data set 12 displayed in step S32 match the switch selection command. If not, two-dimensional/three-dimensional data conversion processing is conducted with respect to the first data set 11 or the second data set 12 according to the switch selection command. For example, if the first data set 11 is originally two-dimensional image data and the second data set 12 is originally time-multiplexed three-dimensional image data, the first data set 11 is converted to three-dimensional image data and the second data set 12 is converted to two-dimensional image data in this step. Thereafter, the flow returns to step S32 to present the first and second data sets 11, 12 thus converted.

This embodiment similarly provides the user with a mechanism that is convenient to operate so as to allow the user to view both two-dimensional and three-dimensional images in the main picture display zone 41 and the sub-picture display zone 42 simultaneously.

In addition, in the embodiments described hereinabove, the number of the sub-picture display zone 42 of the display unit 4 is not limited to one, and may be more than one by using more than one stereoscopic display sheet or by software definition.

In sum, through hardware configuration with respect to the display unit 4 in conjunction with software configuration with respect to the image processing unit 3, the present invention can thus provide a PIP display apparatus capable of two-dimensional and stereoscopic display at the same time.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A picture-in-picture display apparatus having stereoscopic display functionality, comprising:
a receiving unit for receiving a first data set and a second data set;
an image processing unit connected to said receiving unit for determining if the first data set and/or the second data set is three-dimensional image data, and for performing computational processing to convert two-dimensional data to three-dimensional data or vice versa; and
a display unit connected to said image processing unit and having a main picture display zone and a sub-picture display zone, the first data set being correspondingly displayed in said main picture display zone, the second data set being correspondingly displayed in said sub-picture display zone.

2. The picture-in-picture display apparatus having stereoscopic display functionality according to claim 1, wherein said sub-picture display zone of said display unit has a stereoscopic display sheet attached thereto so as to distinguish said sub-picture display zone from said main picture display zone.

3. The picture-in-picture display apparatus having stereoscopic display functionality according to claim 1, wherein said main picture display zone and said sub-picture display zone of said display unit have a stereoscopic display sheet attached thereto, position and size of said sub-picture display zone being software-defined.

4. The picture-in-picture display apparatus having stereoscopic display functionality according to claim 2, wherein said stereoscopic display sheet is one of a polarized sheet and a lenticular sheet.

5. The picture-in-picture display apparatus having stereoscopic display functionality according to claim 3, wherein said stereoscopic display sheet is one of a polarized sheet and a lenticular sheet.

6. The picture-in-picture display apparatus having stereoscopic display functionality according to claim 1, wherein said receiving unit includes two video terminals for receiving the first and second data sets, respectively.

7. The picture-in-picture display apparatus having stereoscopic display functionality according to claim 2, wherein said image processing unit only determines if the second data set is three-dimensional image data, and converts the second data set to three-dimensional image data if the second data set is not three-dimensional image data.

8. The picture-in-picture display apparatus having stereoscopic display functionality according to claim 2, wherein said receiving unit is a connection port adapted for connection to a computer device, and receives a command to open a new window, said display unit opening a window in a position corresponding to said sub-picture display zone and displaying the second data set in said window when said receiving unit receives the command to open a new window.

9. The picture-in-picture display apparatus having stereoscopic display functionality according to claim 8, wherein the command to open a new window is automatically generated when the computer device is connected to an image acquiring or playback device.

10. The picture-in-picture display apparatus having stereoscopic display functionality according to claim 3, wherein said receiving unit further receives a switch command, and said image processing unit performs computational processing to convert two-dimensional data to three-dimensional data or vice versa with respect to one of the first and second data sets when said receiving unit receives the switch command.

11. The picture-in-picture display apparatus having stereoscopic display functionality according to claim 3, wherein said receiving unit further receives a switch command, said image processing unit providing a switch menu for displaying on said display unit when said receiving unit receives the switch command, and wherein, when said receiving unit further receives a switch selection command selecting one of options from the switch menu, said image processing unit performs computational processing to convert two-dimensional data to three-dimensional data or vice versa with respect to the first data set and/or the second data set according to the switch selection command.

12. A picture-in-picture display method to be realized in a display apparatus, said method comprising the following steps:
(a) receiving a first data set and a second data set;
(b) determining if the first data set and/or the second data set is three-dimensional image data;
(c) performing computational processing to convert two-dimensional data to three-dimensional data or to convert three-dimensional data to two-dimensional data; and
(d) displaying the first data set correspondingly in a main picture display zone of the display apparatus, and displaying the second data set correspondingly in a sub-picture display zone of the display apparatus.

13. The picture-in-picture display method according to claim 12, wherein the first and second data sets are received through two different video terminals in step (a).

14. The picture-in-picture display method according to claim 12, wherein the first and second data sets are received through a connection port of the display apparatus which is connected to a computer device in step (a).

15. The picture-in-picture display method according to claim 12, wherein, in step (b), the determination is made only with respect to whether the second data set is three-dimensional image data, and the computational processing to convert two-dimensional data to three-dimensional data in step (c) is performed only with respect to the second data set when the second data set is determined to be not three-dimensional image data in step (b).

16. The picture-in-picture display method according to claim 14, further comprising, after step (a), a step (e1) of receiving a command to open a new window and a step (e2) of opening a window in a position corresponding to the sub-picture display zone, the second data set being displayed in the window thus opened in step (d).

17. The picture-in-picture display method according to claim 12, further comprising, after step (d), a step (f1) of receiving a switch command, and a step (f2) of performing computational processing to convert two-dimensional data to three-dimensional data or vice versa with respect to one of the first and second data sets in response to the switch command.

18. The picture-in-picture display method according to claim 12, further comprising, after step (d), a step (f1) of receiving a switch command, a step (f3) of providing a switch menu in response to the switch command, a step (f4) of receiving a switch selection command selecting one of options from the switch menu, and a step (f5) of performing computational processing to convert two-dimensional data to three-dimensional data or vice versa with respect to the first data set and/or the second data set according to the switch selection command.
